(19) United States
(12) Patent Application Publication
(10) Pub. No.: US 2021/0084960 A1
(43) Pub. Date: Mar. 25, 2021

(54) Hazel's Food

(71) Applicant: Bobby Ray Brown, Modesto, CA (US)

(72) Inventor: Bobby Ray Brown, Modesto, CA (US)

(21) Appl. No.: 17/027,591

(22) Filed: Sep. 21, 2020

Related U.S. Application Data
(60) Provisional application No. 62/903,220, filed on Sep. 20, 2019.

(51) Int. Cl. A23P 10/10; A23L 13/00

(52) U.S. Cl. CPC A23P 10/10; A23V 2002/00; A23L 13/00

(57) ABSTRACT

A meat product offers a user stable construction with a rod engaging a threaded socket inside at least one bone of the meat portion. The meat product allows the user to steadily hold meat products using the user's hands without touching the meat or requiring any cutting beforehand. Additionally, the meat product can be easily taken apart by disengaging the rod from the threaded socket. The meat product may have multiple rods, thus allowing the user to hold heavy meat products. Each rod may comprise a handle which provides efficient and effective handling, processing, cooking and/or eating. The handle may comprise various shapes and a slip resistant surface that offers the user more secure handling. The meat product can be made individually by the user or manufactured in batches. Thus, the meat product allows the user to achieve a sanitary eating product.

The current application claims a priority to the U.S. Provisional Patent application Ser. No. 62/903,220 filed on Sep. 20, 2019.

### FIELD OF THE INVENTION

The present invention relates generally to a meat product. More specifically, the present invention relates to a meat product that can be easily taken apart. Further, the meat product allows a user to hold the meat product for efficient and sanitary handling, processing, cooking, and eating, etc., without using the user's hands in direct contact with the meat or any cutting beforehand.

### BACKGROUND OF THE INVENTION

Currently, cooked meat can be held by silverware, skewers, and/or hands of a user. However, these options have notable inadequacies. If the user uses hands to hold cooked meat, the user's hands can be covered by any product that was previously applied to the cooked meat. Additionally, the user's hands might not be clean, making this option possibly unsanitary. For cooked meat to be held by silverware or skewers, the cooked meat must first be cut into portions that can be held by silverware or skewers. The cutting process can be a hassle making the usage of silverware and skewers inconvenient. Therefore, there is a need for a meat product that can be held without a user's hands in direct contact with the meat and does not require any cutting beforehand.

Currently, skewers are used in many existing meat products that allow the user to hold the meat product using hands without direct contact with the meat. These skewers are primarily nail-type, or pin-type skewers, each of which comprises a pointed end that allows the user to insert the skewer into the meat portion of the meat product. Most of these skewers are not inserted into bones of the meat portion, thus normally do not have a stable construction that provides steady connection to the user for holding the meat product using hands of the user while not touching the meat. Depending on the material of the skewer, the skewer may break, or even collapse during handling, processing, cooking, and/or eating due to the weak connection of the skewer with the meat portion of the meat product, thus causing damages to the meat product, dropping the meat product, etc.

It is an objective of the present invention to provide a solution to the aforementioned drawbacks, problems, and issues associated with the meat product. The present invention offers a meat product that can be easily taken apart while also having a stable construction. The present invention allows the user to steadily hold meat products for handling, processing, cooking, and/or eating using the user's hands without touching the meat or requiring any cutting beforehand.

### SUMMARY OF THE INVENTION

A meat product of the present invention offers a user stable construction with a rod engaging a threaded socket inside the meat portion. The threaded socket can be made using common tools into at least one bone of the meat product. Through this simple but stable construction, the present invention allows the user to steadily hold meat products for handling, processing, cooking, and/or eating using the user's hands without touching the meat or requiring any cutting beforehand. Additionally, the meat product can be easily taken apart by disengaging the rod from the threaded socket on the at least one bone of the meat portion.

The meat product may have multiple rods, each of which is connected to a threaded socket on a bone of the meat portion, thus allowing the user to hold heavy meat products including, but not limited to, large ribs, chicken breasts, heavy drumsticks, whole chicken, turkey, etc. Additionally, each rod may comprise a handle, which may include, but is not limited to, a T-shaped handle, a L-shaped handle, etc., to provide efficient and effective handling, processing, cooking and/or eating. The meat product can be made individually by the user or manufactured in batches. Further, the handle may comprise a slip resistant surface/material/coating/cover that offers the user slip-free feature of the present invention. Thus, the meat product of the present invention not only provides the user with a stable construction that can be easily taken apart, but also allows the user to handle/cook/eat the meat product without touching the meat product to achieve a sanitary eating product for clean eating, easy cooking, easy handling, fast cooking, simple cooking, easy slicing, easy control with a wonderful eating experience: simple, no messy eating/cooking.

### BRIEF DESCRIPTION OF THE DRAWINGS

FIG. 1 is a perspective view of the present invention.

FIG. 2 is a perspective view of the present invention, wherein a rod is detached from a meat portion.

FIG. 3 is a perspective view of the rod engaging a threaded socket of the meat portion.

FIG. 4 is a diagram of the present invention.

FIG. 5 is a perspective view of the present invention with a plurality of rods, wherein one of the plurality of rods comprises a T-shaped handle.

FIG. 6 is a perspective view of the present invention with a plurality of rods, wherein two of the plurality of rods comprise T-shaped handles.

FIG. 7 is a perspective view of the present invention, wherein the rod comprises a L-shaped handle.

FIG. 8 is a perspective view of the meat portion of the present invention.

FIG. 9 is a schematic view of the rod, handle, and tools of the present invention.

FIG. 10 is a perspective view of an alternative embodiment of the present invention with a plurality of rods.

### DETAIL DESCRIPTIONS OF THE INVENTION

All illustrations of the drawings are for the purpose of describing selected versions of the present invention and are not intended to limit the scope of the present invention.

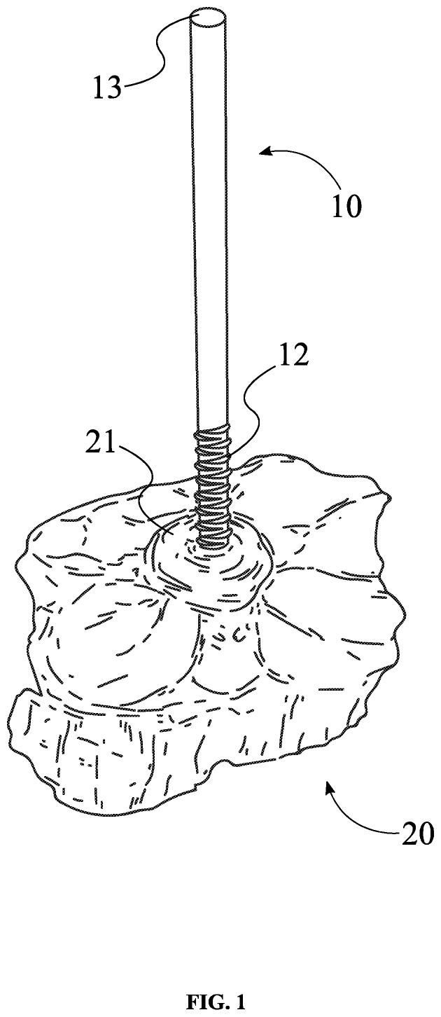

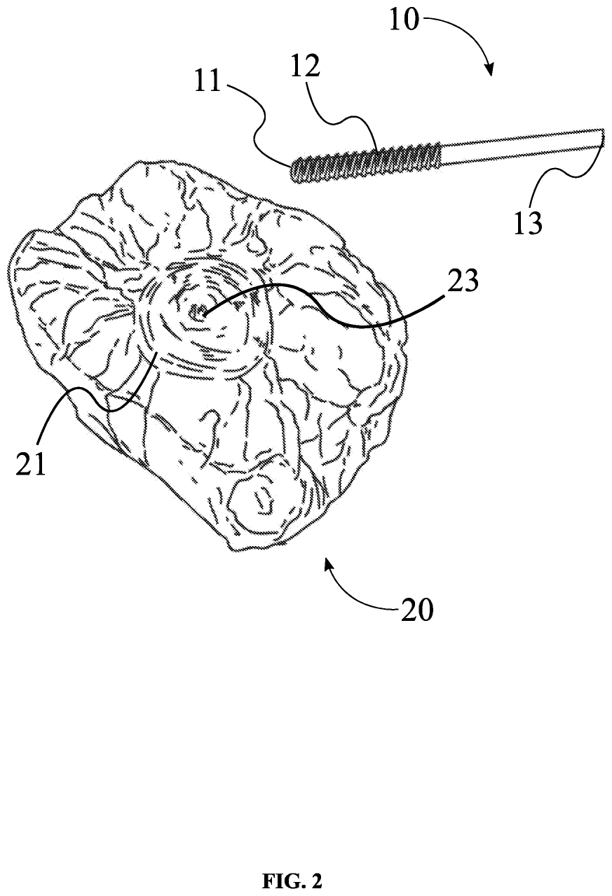

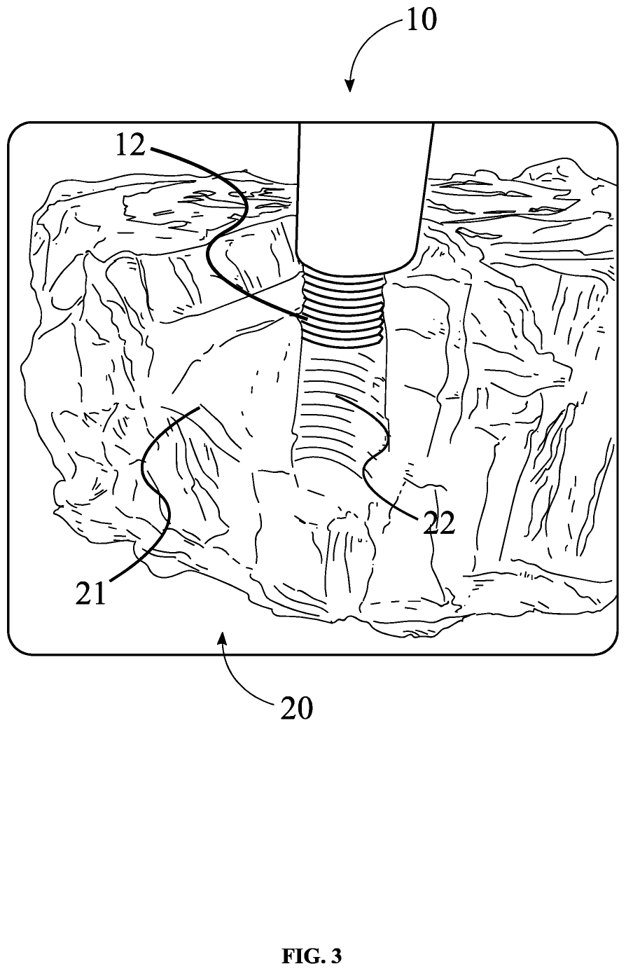

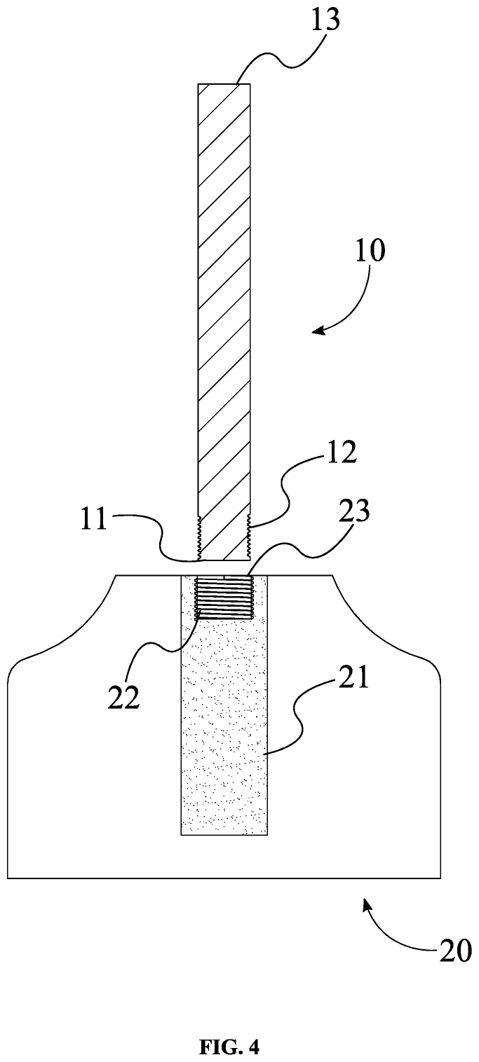

As can be seen in FIG. 1 to FIG. 10, the present invention offers a meat product, that has a stable construction and can be easily taken apart. The meat product allows a user to hold the meat product for efficient and sanitary handling, processing, cooking, and eating, etc., without using the user's hands or any cutting beforehand.

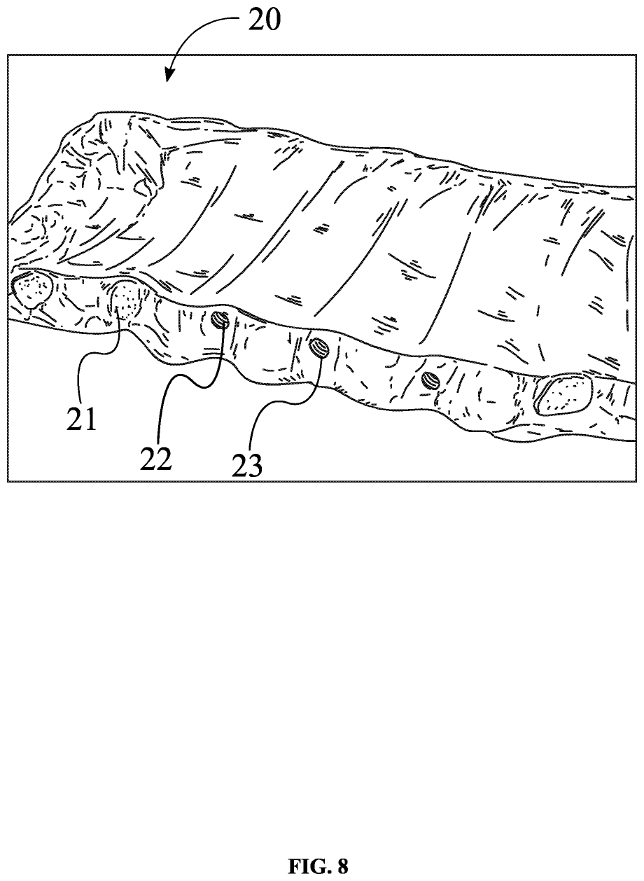

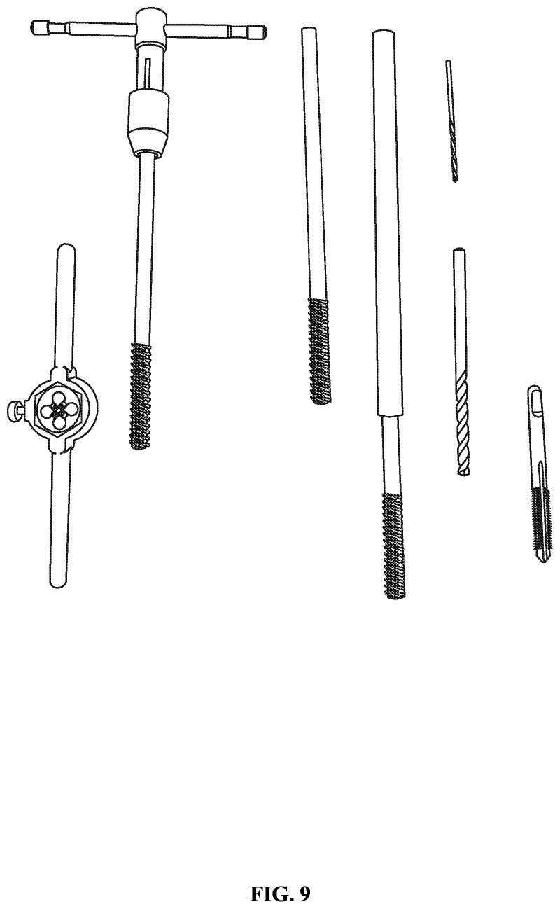

As can be seen in FIG. 1 to FIG. 4, and FIG. 8, the meat product of the present invention comprises a rod 10 and a meat portion 20. More specifically, the rod 10 comprises a distal end 11, thread 12, a proximal end 13. The distal end 11 and the proximal end 13 are terminally positioned on the rod 10, opposite each other. The thread 12 is terminally and concentrically positioned on the rod 10, adjacent the distal end 11. The rod 10 allows the user to easily handle, cook, and/or consume meat without the user's hands directly touching the meat. The rod 10 can be stably attached to the meat portion 20, allowing the present invention to hold cooked meat without any cutting beforehand. In the preferred embodiment of the present invention, the rod 10 can be made of a material including, but not limited to, wood, metal, plastic, composite material, and any other suitable material. The meat portion 20 comprises at least one bone 21 and a threaded socket 22. The at least one bone 21 is positioned within the meat portion 20 and comprises an opening 23. The at least one bone 21 may be encased by the meat portion 20. The opening 23 is exteriorly positioned on the at least one bone 21 providing entry to the rod 10 for connection through the thread 12 of the rod 10. The threaded socket 22 is interiorly and terminally positioned on the at least one bone 21. The threaded socket 22 can be made by using a common tool including but not limited to drill bit, tapping bit, pilot hole bit, etc., as can be seen in FIG. 9. The depth of the threaded socket 22 may include, but is not limited to, a minimum value of one fourth of an inch (¼″), ⅜″ (three eights of an inch) to ½″ (half an inch), or another other suitable depth. The threaded socket 22 allows the rod 10 to attach to the meat portion 20. The opening 23 terminally and concentrically positioned on the threaded socket 22. The opening 23 allows the rod to access and be attached to the at least one bone 21. Additionally, the rod 10 is mounted to the at least one bone 21 of the meat portion 20 through the threaded socket 22 by engaging the thread 12 of the rod 10 with the threaded socket 22. Further, the meat portion 20 allows the present invention to be easily taken apart. The meat portion 20 can be made from meats including, but not limited to, chicken, beef, pork, etc.

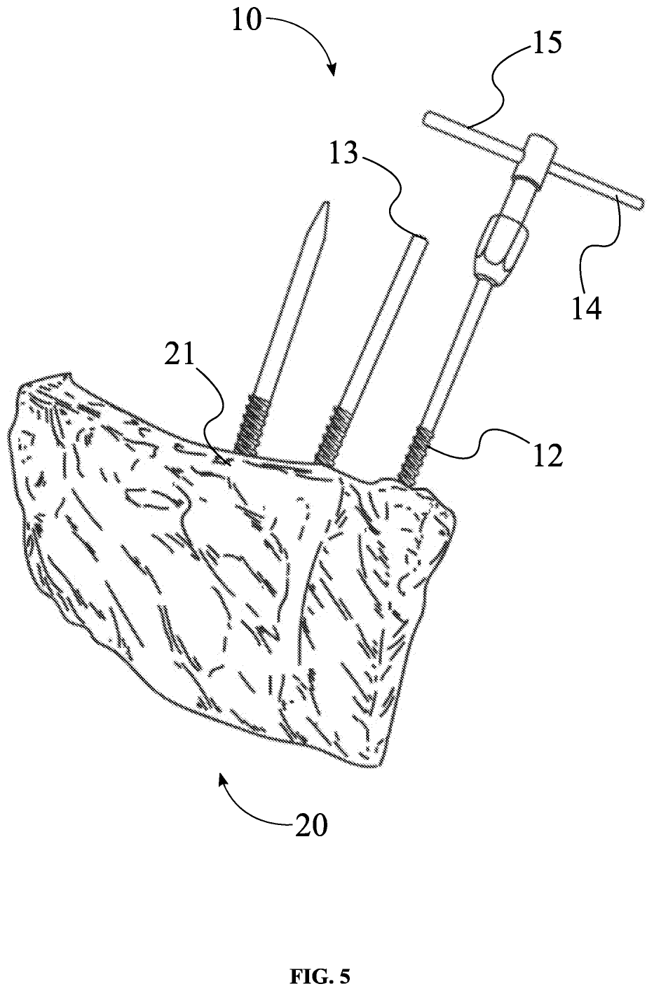

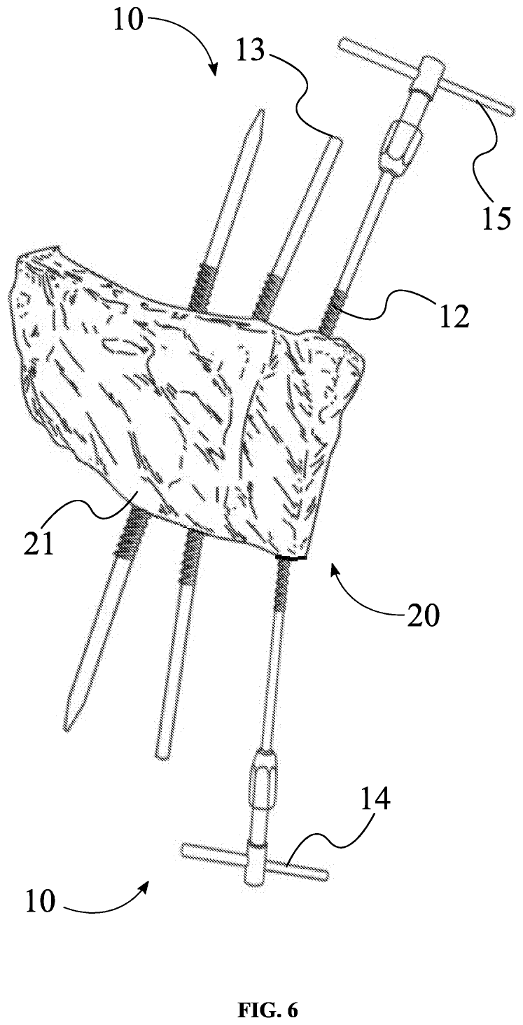

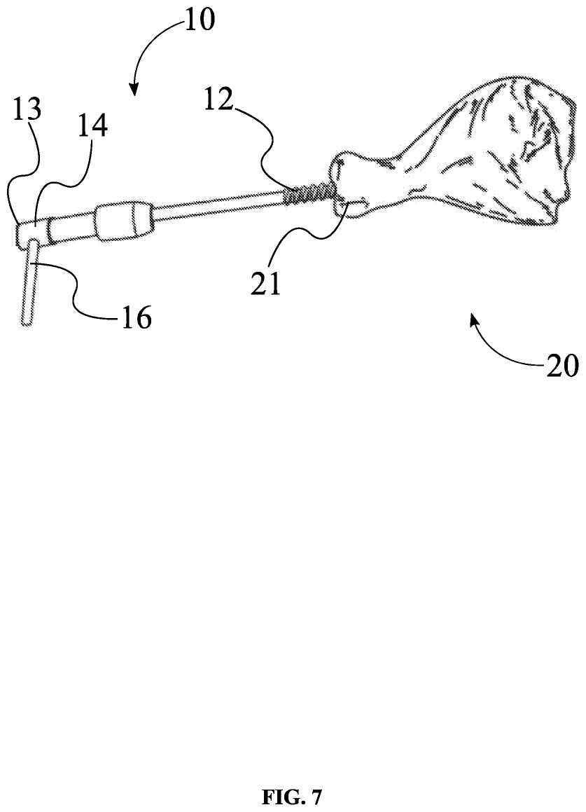

As can be seen in FIG. 5 to FIG. 7, the rod 10 can further comprise a handle 14. The handle 14 is terminally positioned on the rod 10 opposite the thread 12. More specifically, the handle 14 is positioned on the proximal end 13 of the rod 10 and allows the user to easily attach the rod 10 to the meat portion 20 through engaging the thread 12 on the distal end 11 of the rod 10 with the threaded socket 22 of the at least one bone on the meat portion 20. In the preferred embodiment of the present invention, the handle 14 can be a T-shaped handle 15 as seen in FIG. 5 and FIG. 6. In an alternative embodiment, the handle 14 can be a L-shaped handle 15 as seen in FIG. 7. However, it is understood the handle is not limited to these embodiments. Further, the handle 14 may comprises a slip-resistance surface that may include, but is not limited to, a slip-resistant cover, slip-resistant material, slip-resistant coating, etc.

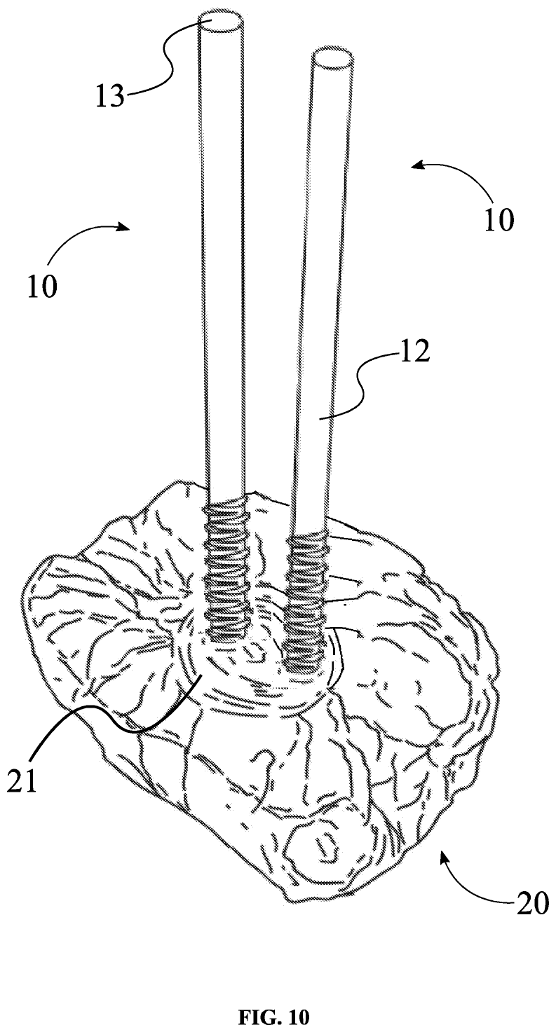

As can be seen in FIG. 6 and FIG. 10, in another embodiment of the present invention, the meat product may comprise a plurality of rods 10. Each of the plurality of rods 10 comprises a distal end 11, a proximal end 13, and a thread 12. Additionally, each of the plurality of rods 10 comprises the same configuration and construction of the rod 10 as described above. The at least one bone 21 of the meat portion 20 comprises a plurality of threaded sockets 22. Each of the plurality of threaded sockets 22 comprises an opening 23. Each of the plurality of rods 10 is interiorly and terminally positioned on the at least one bone 21 and each of the plurality of rods 10 is mounted to the at least one bone 21 of the meat portion 20 through one of the plurality of threaded sockets 22. Further, each of the plurality of rods 10 comprises a handle 14 and the handle 14 is terminally positioned on each of the plurality of rods 10 opposite the thread 12. In other embodiments, as can be seen in FIG. 6, some, not all, of the plurality of rods 10 may comprise the handle 14.

As can be seen in FIG. 10, in yet another embodiment of the present invention, each of the at least one bone 21 of the meat product may comprise a plurality of threaded sockets 22. Each of the plurality of threaded sockets 22 is interiorly and terminally positioned on each of the at least one bone 21. Additionally, each of the plurality of threaded sockets 22 comprises an opening 23. The opening 23 is terminally and concentrically positioned on one of the plurality of threaded sockets 22. If the meat product of the present invention comprises only one bone 21, the plurality of the threaded sockets 22 is positioned on the single bone 21.

Although the invention has been explained in relation to its preferred embodiment, it is to be understood that many other possible modifications and variations can be made without departing from the spirit and scope of the invention as hereinafter claimed.

What is claimed is:

1. A meat product for providing efficient and sanitary handling, processing, cooking, and eating comprising:
a rod;
a meat portion;
the rod comprising a thread;
the thread being terminally and concentrically positioned on the rod;
the meat portion comprising at least one bone and a threaded socket;
the threaded socket being interiorly and terminally positioned on the at least one bone; and
the rod being mounted to the at least one bone of the meat portion through the threaded socket.

2. The meat product for providing efficient and sanitary handling, processing, cooking, and eating as claimed in claim 1 comprising:
the rod comprising a handle; and
the handle being terminally positioned on the rod opposite the thread.

3. The meat product for providing efficient and sanitary handling, processing, cooking, and eating as claimed in claim 2, wherein the handle comprises a T-shaped handle.

4. The meat product for providing efficient and sanitary handling, processing, cooking, and eating as claimed in claim 2, wherein the handle comprises a L-shaped handle.

5. The meat product for providing efficient and sanitary handling, processing, cooking, and eating as claimed in claim 2, wherein the handle comprises a slip-resistant surface.

6. The meat product for providing efficient and sanitary handling, processing, cooking, and eating as claimed in claim 2, wherein the handle comprises a slip-resistant cover.

7. The meat product for providing efficient and sanitary handling, processing, cooking, and eating as claimed in claim 2, wherein the handle comprises a slip-resistant coating.

8. The meat product for providing efficient and sanitary handling, processing, cooking, and eating as claimed in claim 1 comprising:
the rod comprising a distal end and a proximal end;
the distal end being terminally positioned on the rod;
the proximal end being terminally positioned on the rod, opposite the distal end; and
the thread being positioned adjacent the distal end.

9. The meat product for providing efficient and sanitary handling, processing, cooking, and eating as claimed in claim 1 comprising:
the at least one bone of the meat portion comprising an opening;
the opening being exteriorly positioned on the at least one bone; and
the opening being terminally and concentrically positioned on the threaded socket.

10. The meat product for providing efficient and sanitary handling, processing, cooking, and eating as claimed in claim 1 comprising:
each of the at least one bone of the meat portion comprising a plurality of threaded sockets;
each of the plurality of threaded sockets being interiorly and terminally positioned on each of the at least one bone;
each of the plurality of threaded sockets comprising an opening; and
the opening being terminally and concentrically positioned on one of the plurality of threaded sockets.

11. A meat product for providing efficient and sanitary handling, processing, cooking, and eating comprising:
a rod;
a meat portion;
the rod comprising a thread and a handle;
the thread being terminally and concentrically positioned on the rod;
the handle being terminally positioned on the rod opposite the thread;
the meat portion comprising at least one bone and a threaded socket;
the threaded socket being interiorly and terminally positioned on the at least one bone; and
the rod being mounted to the at least one bone of the meat portion through the threaded socket.

12. A meat product for providing efficient and sanitary handling, processing, cooking, and eating comprising:
a plurality of rods;
a meat portion;
each of the plurality of rods comprising a thread;
the thread being terminally and concentrically positioned on each of the plurality of rods;
the meat portion comprising at least one bone;
the at least one bone comprising a plurality of threaded sockets;
each of the plurality of threaded sockets being interiorly and terminally positioned on the at least one bone; and
each of the plurality of rods being mounted to the at least one bone of the meat portion through one of the plurality of threaded sockets.

13. The meat product for providing efficient and sanitary handling, processing, cooking, and eating comprising as claimed in claim 12 comprising:
each of the plurality of rods comprising a handle; and
the handle being terminally positioned on each of the plurality of rods opposite the thread.
